(19) United States
(12) Patent Application Publication
(10) Pub. No.: US 2004/0060780 A1
(43) Pub. Date: Apr. 1, 2004

(54) Parking brake and control device therefor

(76) Inventors: Jean-Pierre Boisseau, Paris (FR); Laurent Verdure, Puteaux (FR)

Correspondence Address: Leo H McCormick Jr, Bosch Braking Systems, 2112 Mishawaka Avenue, PO Box 4721, South Bend, IN, 46634-4721, US

(21) Appl. No.: 10/466,371

(22) PCT Filed: Dec. 19, 2001
(86) PCT No.: PCT/FR01/04065

(30) Foreign Application Priority Data
Jan. 2, 2001 (FR) FR 01/00056

(51) Int. Cl. F16D 55/08

(52) U.S. Cl. 188/72.7; 188/265

(57) ABSTRACT

The invention relates to a control device intended for a parking brake in a motor vehicle, such device converting a rotational motion into a translational motion and comprising a first plate for a controlled rotational motion but incapable of a translation motion, and a second plate unable to rotate but with a free translation motion, said plates including ramps facing each other. A ball is confined between two corresponding ramps in the first and second plates. The rotation of the first plate causes the ball to travel on the corresponding ramp and, therefore, the second plate to carry out a translational motion.

Each ramp of at least one of the plates comprises a band (42) so as to guide the ball in its motion.

This invention relates to a parking brake or a hand brake device for a motor vehicle and, more particularly, to such a device in which, for a translational force to be applied in order to clamp a disk between two brake shoes, a rotational motion, resulting from the hand actuation of the brake, is converted into said translational motion thanks to a ramp-and-ball mechanism (also called a ball-in ramp (or BIR)) which, besides, amplifies or boosts these forces.

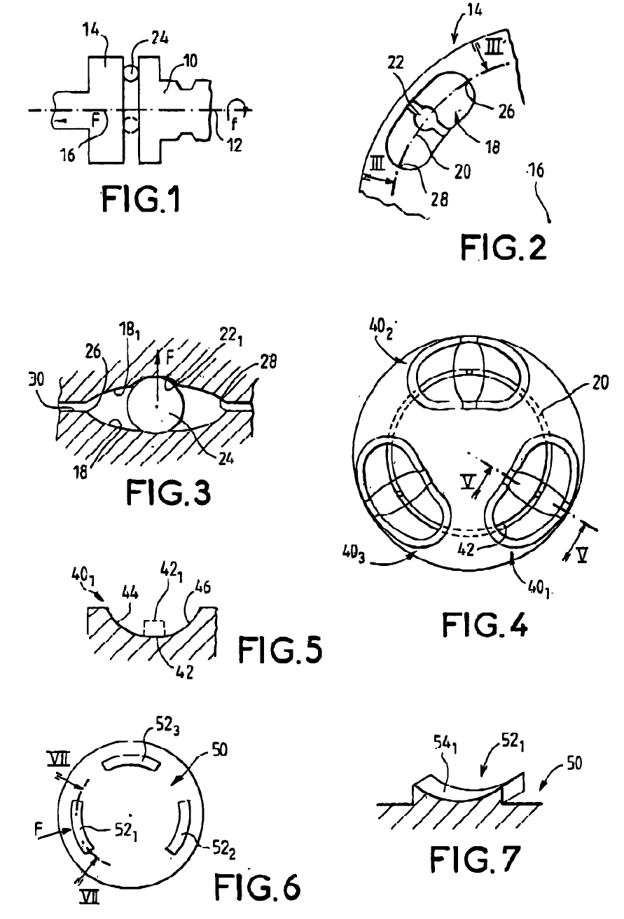

FIGS. 1 through 3 show such a well-known mechanism.

Such motion-converting device comprises (FIG. 1) a first plate 10, incapable of a translation motion but freely rotating about an axis 12, and a second plate 14, unable to rotate but with a free translation motion along an axis 16, colinear with the axis 12.

Each one of the plates 10 and 14 has ramps, e.g. three ramps, equally spaced about the axes 12 and 16. Such ramps are in the shape of pockets or recesses which are illustrated in FIGS. 2 and 3. FIG. 2 is a front view of a plate, for instance the plate 14, perpendicular to the axis 16. The recess 18 has a median longitudinal axis 20 in the shape of an arc of a circle centred on the axis 16, and it exhibits, substantially at the center of said arc of a circle, an indent 22, as shown in FIG. 3 which is a sectional view along line III-III′ in FIG. 2.

A ball 24 is confined between the recess 18 in the plate 14 and the corresponding recess 18, provided in the plate 10. At rest, that is when the parking brake is not actuated, the ball 24 bears into the respective indents 22 and 22₁ of the recesses 18 and 18₁.

In order to actuate the parking brake, a control device is provided, which imparts a rotational motion to the plate 10 so that the latter may rotate about its axis 12. Therefore, since the plate 10 is incapable of a translational motion, the ball rolls down to the bottom of the recess 18 and draws nearer to the end 26 or 28 (FIG. 2), i.e. the plane portion 30 of the plate 14. It results in that the ball 24 pushes back the plate 14 in the direction of the arrow F (FIGS. 1 and 3).

Such a device, which converts a rotational force into a translational one, operates quite well if the balls follow the median lines or profiles 20 of each one of the recesses or impresses 18. Yet it is no longer true when the axes 12 and 16 of the plates are not aligned, whether because of the actual working of the brake or on account of factory tolerances. So, it was found that, when the balls do not follow the line 20, some jamming may appear, which means that greater forces must be exerted so as to actuate the parking brake. Moreover, such forces bring about internal stresses in the metal which the plates are made of, i.e. a strain in the plates and, as a consequence of it, still greater forces have to be applied.

This invention copes with such disadvantages in that, thanks to it, the device can work correctly in spite of misalignments of the plate axes and/or despite factory tolerances.

With this object in view, in the device according to the invention, there is provided a guiding band for the ball, along a desired path or profile, on one of the plates, so as not to subject the ball to stresses likely to disturb the operation of the device, in the case of a misalignment of the plate axes or of factory tolerances.

According to an embodiment of the present invention, the guiding band is arranged at the bottom of each one of the impresses provided in at least one plate, in which case said band consists of a flat bottom, or more generally, it is a band having a radius of curvature which is substantially greater than the radius of curvature of the impress near said band. When the guiding band is at the bottom of an impress, such band may result from a stamping operation carried out on the plate-forming metal, at the spot where said band must be provided.

As a variant, the band may form a protrusion at the bottom of each impress.

In another embodiment of the invention, the band directly protrudes from an impressless plate.

Therefore, whatever its mode of manufacturing may be, the device according to the present invention can be implemented in a particularly simple way, and it precludes jamming problems in spite of considerable factory tolerances or of non-coaxial positions of the plates.

The band width is selected so as to take up the maximum possible misconcentricity of the plates.

In general, the invention relates to a control device intended for a parking brake in a motor vehicle, such device converting a rotational motion into a translational motion and comprising a first plate for a controlled rotational motion but incapable of a translation motion, and a second plate unable to rotate but with a free translation motion, said plates including ramps facing each other and a ball being confined between two corresponding ramps in the first and second plates, wherein the rotation of the first plate causes the ball to travel on the corresponding ramp and, therefore, the second plate to carry out a translational motion. Said device is characterised in that each ramp of at least one of the plates comprises a band so as to guide the ball in its motion.

According to an embodiment, in at least one of the plates, the ramps are part of impresses provided in a face of the plate and the guiding bands are situated at the bottom of each one of the impresses, in which case the guiding band is, e.g. substantially plane or has a radius of curvature substantially greater than the radius of curvature of the adjacent portions of the impress. In a practical example, the guiding band blends smoothly into the other portions of the impress, since the guiding band consists, e.g., of a stamped metal portion.

The guiding band may protrude from the bottom of the impress.

In accordance with another aspect, the guiding band forms the apices of ramps protruding from a face of at least one of the plates.

In an implementation of the present invention, the projection of the guiding band on a plane of the corresponding plate forms an arc of a circle centred on the axis of said plate.

Each plate includes, for instance, three ramps.

The present invention also deals with a parking brake, characterised in that it comprises a control device of the above-defined type.

Other features and advantages of the present invention will be apparent from the following detailed description of some embodiments, by way of example and by no means as a limitation, when taken in conjunction with the accompanying drawings, in which:

FIGS. 1 through 3, which have already been described, show a device for the conversion of a rotational motion into a translational motion and intended for a well-known parking brake;

FIG. 4 is a front view of a plate of a device according to the present invention

FIG. 5 is a sectional view along line V-V in FIG. 4;

FIG. 6 is a view, similar to FIG. 4, of a variant; and

FIG. 7 is a perspective sectional view along line VII-VII in FIG. 6.

FIG. 5 shows an embodiment according to this invention, in which the plate 10, which is incapable of a translation motion but which can freely rotate about the axis 12, comprises three impresses 40₁, 40₂ and 40₃ generally with the same shape as that of the impresses 18, previously described in connection with FIGS. 1 through 3, but differing from the latter in that, along the arc of a circle 20, a guiding band 42 is provided at the bottom of each impress and in that it consists of a flattened portion of the pocket bottom or of a part of a radius of curvature substantially greater than the radius of curvature of the sidewalls 44 and 46 (FIG. 5) of the pocket, on either side of said band 42.

Such guiding band is provided in one plate only. Nevertheless, it may be provided either in the plate 10, incapable of a translational motion, or in the plate 14, which is unable to rotate.

In such a way, through a very simple alteration in one of the plates, the present invention solves the problem of a misalignment of the plates, without requiring any additional parts.

In a variant, as shown by broken lines in FIG. 5, the band 42₁ forms a protrusion situated on the bottom of an impress.

According to another variant in FIGS. 6 and 7, a plate (not shown) comprises conventional impresses, with no guiding bands, and another plate 50 exhibits guiding bands 52₁, 52₂ and 52₃ (FIG. 6) protruding from a face of the plate and arranged facing the impresses provided in the other plate. The protrusion 52₁ ends, as illustrated in FIG. 7, in the opposite direction to the main surface of the plate 50, in a band 54₁ with a path like that of the band 20 in FIG. 4.

The present invention mainly applies to the design and manufacturing of braking systems for motor vehicles and, especially, for private cars.

We claim:

1. A control device intended for a parking brake in a motor vehicle, said device converting a rotational motion into a translational motion and comprising a first plate (10) for a controlled rotational motion but incapable of a translation motion, and a second plate (14) unable to rotate but with a free translation motion, said plates including ramps facing each other and a ball being confined between two corresponding ramps in the first and second plates, wherein the rotation of the first plate causes the ball to travel on the corresponding ramp and, therefore, the second plate to carry out a translational motion, characterised in that each ramp of at least one of the plates comprises a band (42, 42₁, 54₁) so as to guide the corresponding ball in its motion.

2. The device according to claim 1, characterised in that, in at least one of the plates, the ramps are part of impresses provided in a face of the plate and in that the guiding bands (42, 42₁) are situated at the bottom of each one of the impresses.

3. The device according to claim 2, characterised in that the guiding band is substantially plane or has a radius of curvature substantially greater than the radius of curvature of the adjacent portions (44, 46) of the impress.

4. The device according to claim 2, characterised in that the guiding band (42) blends smoothly into the other portions of the impress.

5. The device according to claim 4, characterised in that the guiding band consists of a stamped metal portion.

6. The device according to claim 3, characterised in that the guiding band (42) protrudes from the bottom of the impress.

7. The device according to claim 1, characterised in that the guiding band (54₁) forms the apices of ramps protruding from a face of at least one of the plates.

8. The device according to claim 1, characterised in that the projection of the guiding band on a plane of the corresponding plate forms an arc of a circle centred on the axis of said plate.

9. The device according to claim 1, characterised in that each plate includes three ramps.

10. The device according to claim 1, characterised in that it controls a parking brake.
